(19) United States
(12) Patent Application Publication
(10) Pub. No.: US 2012/0133183 A1
(43) Pub. Date: May 31, 2012

(54) SUSPENSION ASSEMBLY OF VEHICLE SEAT

(75) Inventors: Tae Hyung Kim, Gunpo-si (KR); Bong Joon Lee, Hwaseong-si (KR); Dong Woo Jeong, Hwaseong-si (KR); Chan Ki Cho, Gwangju (KR)

(73) Assignees: Hyundai Motor Company, Seoul (KR); Dae Chang Seat Co., Ltd., Gyeongju (KR); Kia Motors Corporation, Seoul (KR)

(21) Appl. No.: 13/167,529

(22) Filed: Jun. 23, 2011

(30) Foreign Application Priority Data
Nov. 29, 2010 (KR) 10-2010-0119625

(51) Int. Cl. B60N 2/66; B60N 2/68; A47C 7/46

(52) U.S. Cl. 297/284.4

(57) ABSTRACT

A suspension assembly of a vehicle seat may include a lumbar plate disposed within an edge of a seat back frame, and an elastic wire section connecting the edge of the seat back frame with a side of the lumbar plate, wherein the elastic wire section includes a first elastic wire, opposite ends of which may be connected to one edge of the seat back frame and at least a portion thereof may be supported by one side of the lumbar plate, and a second elastic wire, opposite ends of which may be connected to the other edge of the seat back frame and at least a portion thereof may be supported by the other side of the lumbar plate.

### CROSS-REFERENCE TO RELATED APPLICATIONS

The present application claims priority to Korean Patent Application No. 10-2010-0119625 filed on Nov. 29, 2010, the entire contents of which is incorporated herein for purposes by this reference.

### BACKGROUND OF THE INVENTION

1. Field of the Invention

The present invention relates, in general, to a suspension assembly of a vehicle seat and, more particularly, to a suspension assembly of a vehicle seat which effectively absorbs shocks using an elastic wire connected to an edge of a lumbar plate and thus is capable of improving comfort for an occupant.

2. Description of Related Art

Generally, vehicle seats are mounted within a range of restricted space and weight of a vehicle to support occupants in a safe, pleasant manner.

To this end, the seat back includes a seat back frame and a seat back pad to support the waist or back of a driver and passengers. However, it is somewhat difficult to completely adapt to changes in an occupant's seating position during long-distance travel only using the seat back frame and the seat back pad, so that the seat back is equipped therein with a shock absorber for surrounding the occupant's back in comfort and a suspension device for comfortably supporting the occupant's lumbar region.

The suspension device is composed of a plurality of cross wires disposed in a lateral direction of the seat back and a boundary wire disposed in a vertical direction of the seat back to fix the cross wires. That is, the suspension device is configured so that the cross wires are arranged in the left-right direction of the seat back and the boundary wire is arranged in the vertical direction of the seat back and binds the cross wires.

However, since in the conventional suspension device, the cross wires are mounted in the lateral direction relative to the occupant's waist, the occupant then feels discomfort. Further, since the entire of the suspension device is supported by the cross wires and the boundary wire, the entire supporting strength decreases and the manufacturing cost increases.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a suspension assembly of a vehicle seat which effectively supports the occupant's back or the like to provide comfort while traveling by vehicle.

In an aspect of the present invention, the suspension assembly of a vehicle seat, may include a lumbar plate disposed within an edge of a seat back frame, and an elastic wire section connecting the edge of the seat back frame with a side of the lumbar plate, wherein the elastic wire section may include a first elastic wire, opposite ends of which may be connected to one edge of the seat back frame and at least a portion thereof may be supported by one side of the lumbar plate, and a second elastic wire, opposite ends of which may be connected to the other edge of the seat back frame and at least a portion thereof may be supported by the other side of the lumbar plate.

The elastic wire section may include a support extending in a longitudinal direction of the lumbar plate to support the lumbar plate and coupled to the lumbar plate, extensions extending from upper and lower ends, respectively, of the support towards the outside of the lumbar plate, and a hook formed on an end of the extension.

The elastic wire section further may include an elastically-deformable bent part formed between the support and the extension in a shape of a letter ‘U’.

The lumbar plate may be provided on opposite sides thereof with a coupler section to which a portion of the elastic wire section may be inserted and fixed, wherein the coupler section may include an engaging piece forcedly supporting one side of a circumference of the elastic wire section in a first direction, and an elastic supporting piece disposed spaced apart from the engaging piece to forcedly support in a direction opposite to the first direction, the other side of the circumference of the elastic wire section.

The coupler section further may include an elastic engaging piece shaped in a hook extending from a surface of the lumbar plate to support a portion of the elastic wire section, wherein the engaging piece has a vertical part extending from one side of the lumbar plate, a horizontal part extending from opposite ends of the vertical part towards the inside of the lumbar plate, an engaging step to receive a portion of the elastic wire section, and a reinforcing part downwardly inclined outwards from an upper end of the vertical part.

The engaging step extends from a lower end of the horizontal part.

In another aspect of the present invention, the suspension assembly of the vehicle seat may further include a fixing wire section, opposite ends of which may be respectively connected to opposite edges of the seat back frame to elastically support a lower side edge of the lumbar plate, wherein the fixing wire section may include a horizontal fixing part extending in a widthwise direction along the lower edge of the lumbar plate and coupled to the lumbar plate, vertical fixing parts extending vertically upwards from opposite ends of the horizontal fixing part respectively, and a frame fixing part extending from an end of the vertical fixing part towards the outside of the lumbar plate and having an end fixed to one side of the seat back frame.

The fixing wire section further may include an elastically-deformable bent portion formed between the frame fixing part and the vertical fixing part in a shape of a letter ‘U’.

The lumbar plate may be provided on a lower end edge thereof with a fitting piece for fixing the horizontal fixing part of the fixing wire section to the lumbar plate, wherein the fitting piece may include a pair of opposite sidewalls with a lengthwise insertion slot formed therebetween and a fixing groove to fix the horizontal fixing part therein.

The vertical fixing part may be coupled to the lumbar plate by an engaging piece.

The lumbar plate may be curved in a widthwise direction into an irregular form.

The lumbar plate may include a plurality of openings defined by a plurality of lengthwise ribs and a plurality of widthwise ribs, wherein the lengthwise rib may be provided with at least one elastically-deformable bent portion, and wherein the at least one elastically-deformable bent portion may include a pair of slant faces inclined towards a back side of the lumbar plate between adjacent widthwise ribs, and a connecting face connecting the pair of slant faces, and wherein a reinforcing rib may be provided in at least one of the lengthwise rib and widthwise rib.

According to the present invention, the invention provides outstanding effects as follows:

First, the invention increases a contact area between the occupant's back and the lumbar plate during vehicle operation and effectively absorbs shocks through the elastic wire section connected to the edge of the lumbar plate, thereby advantageously improving the occupant's comfort.

Second, the invention provides self-elasticity by realizing the lumbar plate having widthwise irregularities, while supporting the occupant's back with a rigid lumbar plate, thereby advantageously absorbing a portion of shock applied during vehicle operation.

Third, the invention provides a simple structure between the lumbar plate and the elastic wire section, thereby advantageously reducing the number of manufacturing processes and the manufacturing cost, and the possibility of failure, and facilitating assembly.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a front-side perspective view of a suspension assembly of a vehicle seat according to an exemplary embodiment of the present invention.

FIG. 2 is a rear-side perspective view of the suspension assembly of a vehicle seat according to the exemplary embodiment of the present invention.

FIG. 3 is an exploded perspective view of FIG. 2.

FIG. 4A is a partially enlarged view of a coupler of FIG. 3.

FIG. 4B is a partially enlarged view of an elastic hook piece and an engaging insert piece.

FIG. 5 is a front view of the suspension assembly of a vehicle seat according to the exemplary embodiment of the present invention.

FIG. 6 is a rear view of the suspension assembly of a vehicle seat according to the exemplary embodiment of the present invention.

FIG. 7 is a side view of the suspension assembly of a vehicle seat according to the exemplary embodiment of the present invention.

FIG. 8 is a view showing a suspension assembly of a vehicle seat according to the exemplary embodiment of the present invention being used.

FIG. 9 is a front view showing another embodiment of the invention in which a cut-hole is formed in the lumbar plate.

FIG. 10 is a front view showing still another embodiment of the invention in which upper and lower cut-holes in a pair are formed in the lumbar plate.

FIG. 11 is a front view showing a further embodiment of the invention in which cut-holes are formed in opposite edges, respectively, of the lumbar plate.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

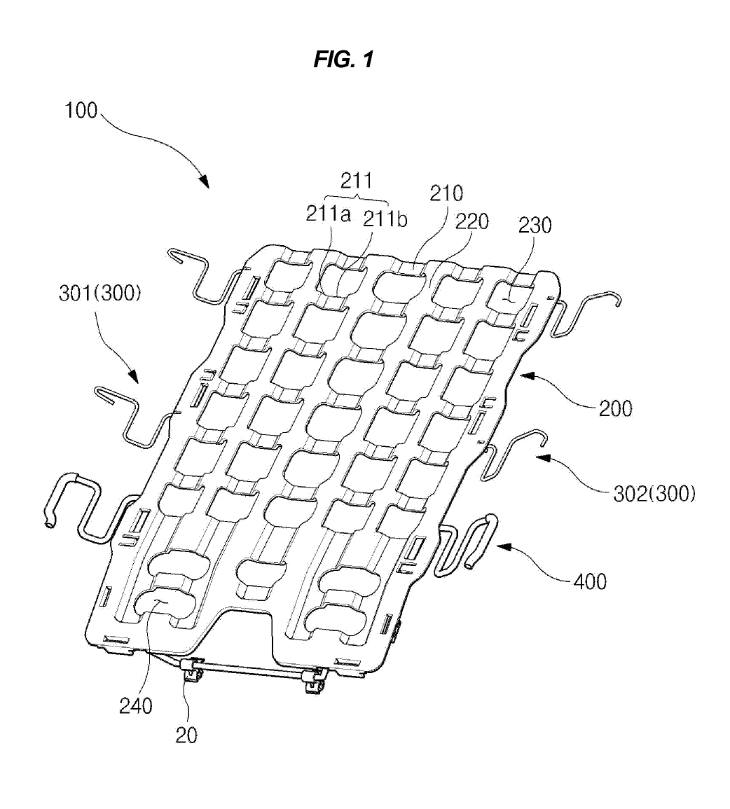

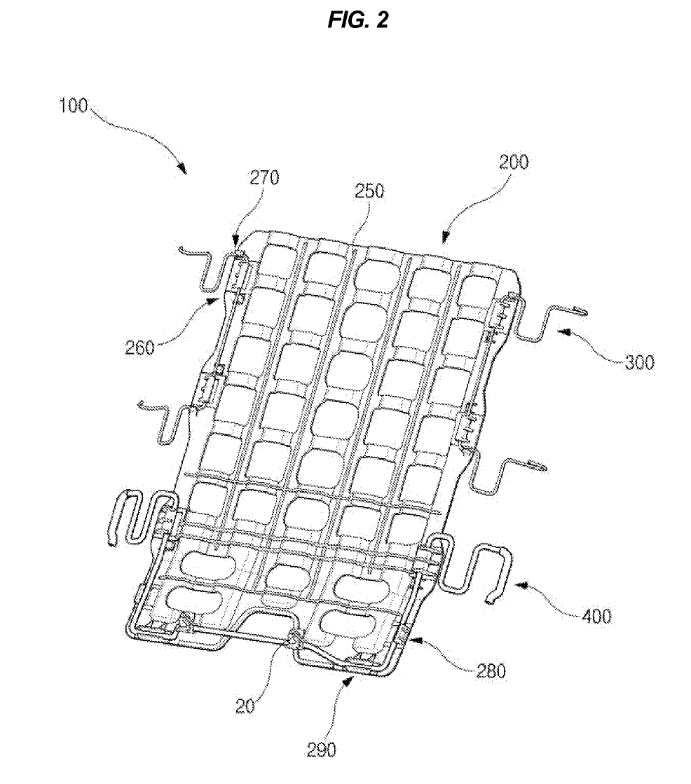

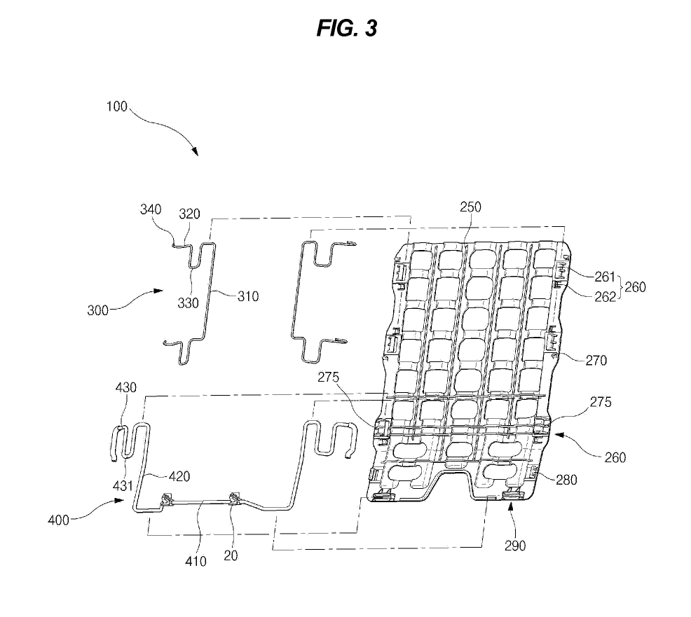

As shown in FIGS. 1-3, a suspension assembly 100 of a vehicle seat according to an exemplary embodiment of the present invention absorbs shocks occurring during vehicle operation to protect an occupant and provide comfort to the occupant by providing first and second elastic wires 301 and 302, which are elastically connected between opposite sides of a lumbar plate 200 and edges of a seat back frame 10, respectively.

The suspension assembly 100 includes the lumbar plate 200 which is disposed inside the edge of the seat back frame 10 to support the occupant's back, the first and second elastic wires 301 and 302 which respectively connect the opposite sides of the lumbar plate 200 and the edges of the seat back frame 10 to each other, and a fixing wire section 400 which is connected to opposite edges of the seat back frame 10 while supporting a lower side edge of the lumbar plate 200.

The lumbar plate 200 is shaped like a plate with a certain thickness, made of an elastic material, and is disposed inside the edge of the seat back frame 10. Further, the lumbar plate 200 is provided with a plurality of openings 230, defined by a plurality of lengthwise and widthwise ribs 210 and 220, in the upper side, and is also provided with at least one oval hole 240, which is spaced apart from another hole if two or more oval holes exist. Here, the four corners of the opening 230 should preferably be round. The openings 230 and the oval holes 240 serve to increase the elasticity of the lumbar plate 200 and also to reduce in the amount of material used and weight.

Further, an air-conditioning duct may be connected to the inside of the vehicle seat in order to supply cool or hot air for air conditioning. The air conditioning duct is mounted in a direction from the back side towards the front side of the lumbar plate 200, so that cool or hot air can be supplied to the occupant's back through the openings 230 and the oval holes 240. A separate through-hole may be formed in one side of the lumbar plate 200 to mount the air conditioning duct therethrough.

The lengthwise rib 210 of the lumbar plate 200 is provided with at least one bent portion 211. The bent portion 211 may include a pair of slant faces 211a, which are inclined towards the back side of the lumbar plate 200 between the adjacent widthwise ribs 220 such that they confront each other, and a connecting face 211b connecting the pair of slant faces 211a. The bent portion 211 can cause the lengthwise rib 210 to be elastically-deformable with variation in extension and compression thereof.

Here, to reinforce the strength of the longwise and widthwise ribs 210 and 220, a reinforcing rib 250 may be provided in any at least one of the lengthwise and widthwise ribs 210 and 220.

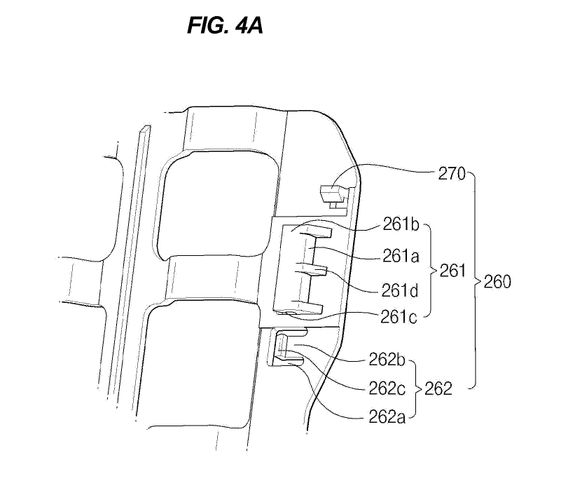

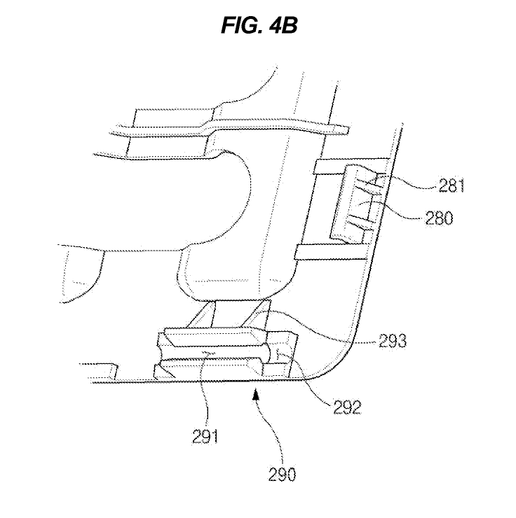

As shown in FIGS. 4A and 4B, a coupler section 260 is provided in the back face of the lumbar plate 200 to engage the elastic wire section 300 to be inserted thereto. The coupler section 260 includes an engaging piece 261 which forcedly supports one side of a circumference of the elastic wire section 300 towards the lumbar plate 200, an elastic supporting piece 262 which forcedly supports the other side of the circumference of the elastic wire section 300 in the opposite direction of the engaging piece 161, and an elastic engaging piece 270 which supports the extension 320 of the elastic wire section 300.

Particularly, the engaging piece 261 has a vertical part 261a which extends from one side of the back face of the lumbar plate 200 towards the back side, a horizontal part 261b which extends horizontally from, i.e. perpendicular to opposite ends of the vertical part towards the inside of the lumbar plate 200, an engaging step 261c which extends from a lower end of the horizontal part 261b towards the back face of the lumbar plate 200, and a plurality of reinforcing parts 261d downwardly inclined to reinforce the vertical part 261a.

The elastic supporting piece 262 is arranged spaced apart a distance from the engaging piece 261 in a longitudinal direction of the lumbar plate 200. The elastic supporting piece 262 includes a cutout part 262a which is cut out in the shape of the letter ‘U’ from one side of the lumbar plate 200, and a support part 262b which is a remaining portion and which has, on an end, a vertical engaging protrusion 262c.

Here, in order to allow the elastic wire section 300 to be easily inserted into the engaging piece 261 and the elastic supporting piece 262, an end of the horizontal part 261b of the engaging piece 261 may preferably be inclined towards the outside of the lumbar plate 200, and an end of the engaging protrusion 262c of the elastic supporting piece 262 may preferably be inclined towards the inside of the lumbar plate 200.

Thus, when the elastic wirer section 300 is assembled to the lumbar plate 200, the elastic wire section 300 climbs over the engaging protrusion 262c while elastically deforming the support part 262b, and then comes into close contact with the vertical part 261a along the inclined portion formed on the end of the horizontal part 261b. Thus, the elastic wire section 300 is prevented from disengaging in the outside and inside of the lumbar plate 200 by the vertical part 261a, and both the engaging step 261c and the engaging protrusion 262c, respectively. Further, since the support part 262b forcedly supports the elastic wire section 300 against the horizontal part 261b by means of elastic force, the elastic wire section is fixedly caught between the engaging piece 261 and the elastic supporting piece 262.

The elastic engaging piece 270 protrudes from the back face of the lumbar plate towards the back side of the lumbar plate 200, and an end thereof is provided with a hook to forcedly support the extension 320. Here, the hook has an inclined face to facilitate assembly of the extension thereto.

The elastic wire section 300 includes a first elastic wire 301 and a second elastic wire 302, which are coupled to opposite sides of the back face of the lumbar plate 200, respectively. The elastic wire section 300 includes a support 310 which extends in a longitudinal direction of the lumbar plate 200 so as to be fixedly caught between the engaging piece 261 and the elastic supporting piece 262, extensions 320 which extend from upper and lower ends, respectively, of the support 310 towards the outside of the lumbar plate 200 so as to be caught by the elastic engaging piece 270, a bent part 330 which is bent into shaped like the letter ‘U’ on the extension 320, and a hook 340 which is formed on an end of the extension 320 so as to be coupled to one side of the seat back frame 10. Here, as the bent part 330 of the elastic wire section 300 expands and is compressed, the elastic wire section 300 is able to be elastically deformable.

While the present embodiment has described that the pair of the coupler sections 260 is respectively provided in order to connect upper and lower portions of a single elastic wire section 300, e.g. the first elastic wire 301 to the lumbar plate 200, the size or number of the coupler sections 260 may vary in a variety of forms according to changes in the length or shape of the elastic wire section.

A fixing wire section 400 is further provided along a lower edge of the lumbar plate and supports the lower portion of the lumbar plate and in which the opposite end thereof is connected to opposite edges of the seat back frame.

The fixing wire section includes a horizontal fixing part 410 which extends in a widthwise direction of the lumbar plate 200, vertical fixing parts 420 which extends vertically upwards from opposite ends, respectively, of the horizontal fixing part 410, and a frame fixing part 430 which extends from an end of the vertical fixing part 420 towards the outside of the lumbar plate 200 and having an end fixedly inserted into one side of the seat back frame 10.

The frame fixing part 430 has, in one side, an elastically-deformable bent portion bent into the shape of the letter ‘U’, and one side of the horizontal fixing part 410 protrudes a distance in a direction of the back side of the lumbar plate 200 and is clamped to the other side of the seat back frame 10 by means of a separate fixing clip 20.

In the meantime, the lumbar plate 200 is provided in lower opposite sides with coupler sections 260, respectively, to fix the upper side of the vertical fixing part 420. The coupler section 260 is similar to the above-mentioned coupler section 260 for fixing the elastic wire section 300, so a detailed description thereof will be omitted.

The lumbar plate 200 is provided in the lower opposite end sides with elastic hook pieces 280, respectively, to fix the lower side of the vertical fixing part 420. A reinforcing part 281 is formed outside of the elastic hook piece 280.

The lumbar plate 200 is provided on the lower end edge with a fitting piece 290 for fixing the horizontal fixing part 410. The fitting piece 290 includes a pair of opposite sidewalls with a lengthwise insertion slot 291 formed therebetween. The insertion slot 291 is tapered such that a width decreases from an upstream portion towards a downstream portion, and has, in the bottom, a fixing groove 292 with a sectional shape of the horizontal fixing part 410 to fix the horizontal fixing part 410 therein. Here, since upon deformation of the lumbar plate 200, an external force is mainly exerted to the upper sidewall, an inclined reinforcing portion 293 is preferably formed to the upper sidewall towards the inside of the lumbar plate 200.

In an exemplary embodiment of the present invention, the vertical fixing part 420 may be coupled to the lumbar plate 200 by an engaging piece 275. Since the engaging piece 275 is the same as the engaging piece 261 or the fixing piece 290, detailed explanation is omitted.

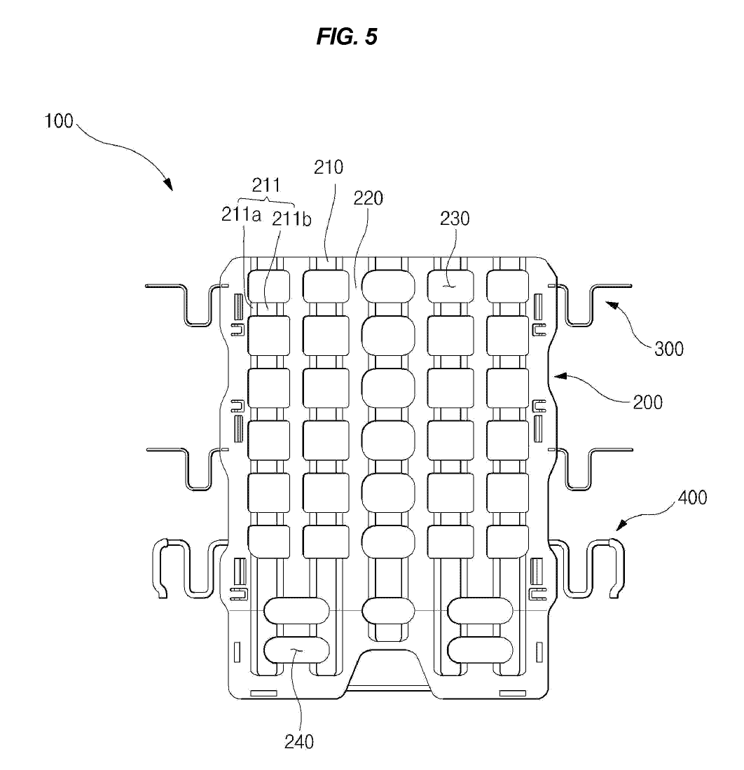

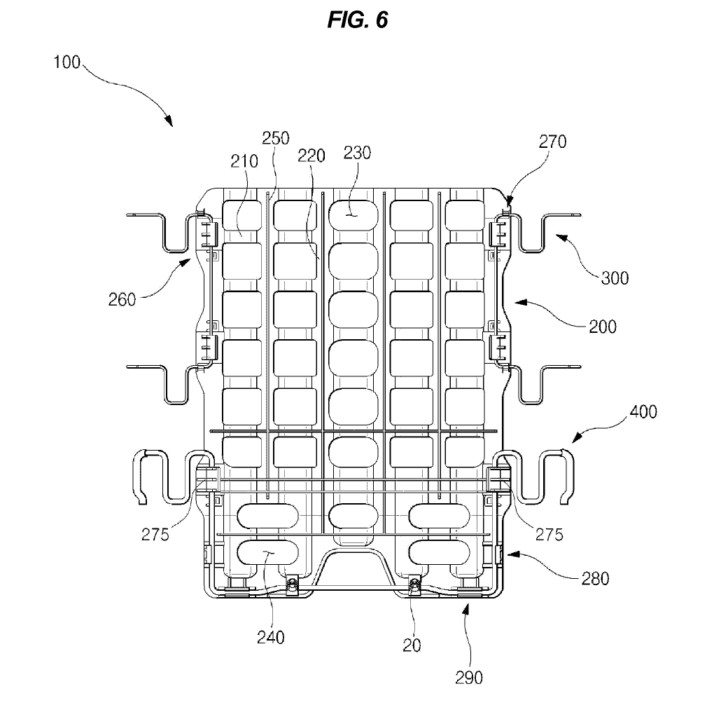

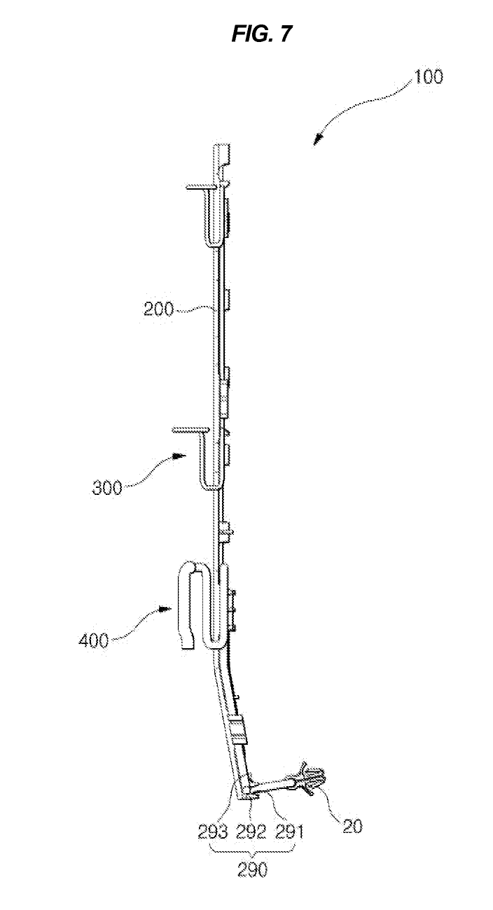

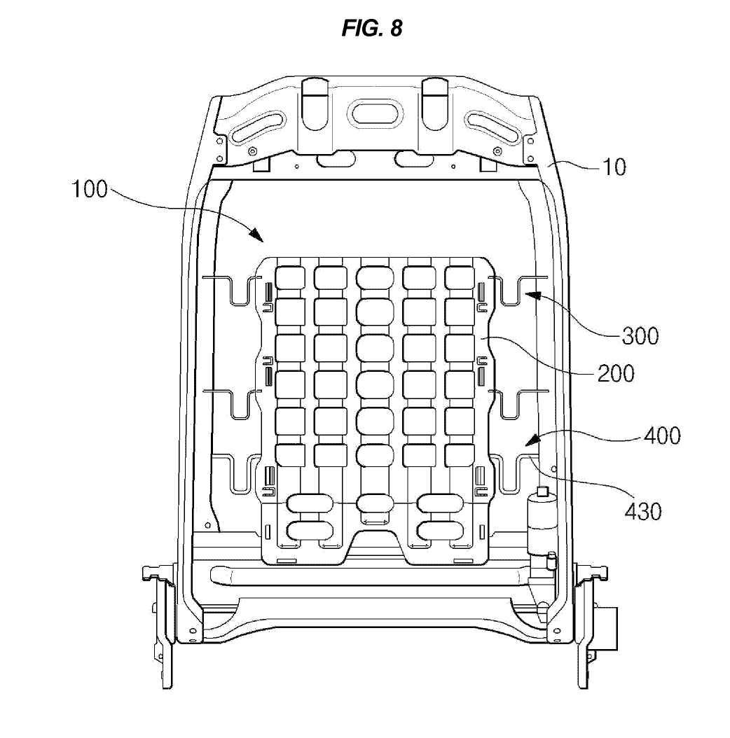

As shown in FIGS. 5 through 8, according to the suspension assembly 100 of a vehicle seat, the end portion of the frame fixing part 430 of the fixing wire section 400, which is coupled to the lower end of the lumbar plate 200, is inserted into and coupled to the seat back frame 10, the horizontal fixing part 410 is fixed to the seat back frame 10 by means of the fixing clip 20, and the hook 340 which is provided on the end of the elastic wire section 300 engages with a hole or a loop of the seat back frame 10, thereby completing mounting of the suspension assembly 100 of a vehicle seat to the seat back frame 10.

Then, when an occupant leans his or her back against the seat back, the lumbar plate 200 is pulled slightly backwards and is deformed such that opposite sides about the vertical center line of the lumbar plate 200 surrounds the occupant's back, thereby providing a comfortable ride. The deformation is performed by elastic deformation of the bent part 330 of the elastic wire section 300 and the bent portion 211 of the lengthwise rib 210.

Further, shocks occurring during vehicle operation are absorbed in part by the bent part 330 and the bent portion 211, and if a great amount of external force is applied, the external force is absorbed in part by an elastically-deformable part 431 of the fixing wire section 400, thereby preventing an occupant from suffering injury.

Furthermore, the air conditioning duct which is introduced in the vehicle seat supplies cool or hot air thereto. Here, the cool or hot air can be delivered towards the occupant's back through the openings 230 and the oval holes 240.

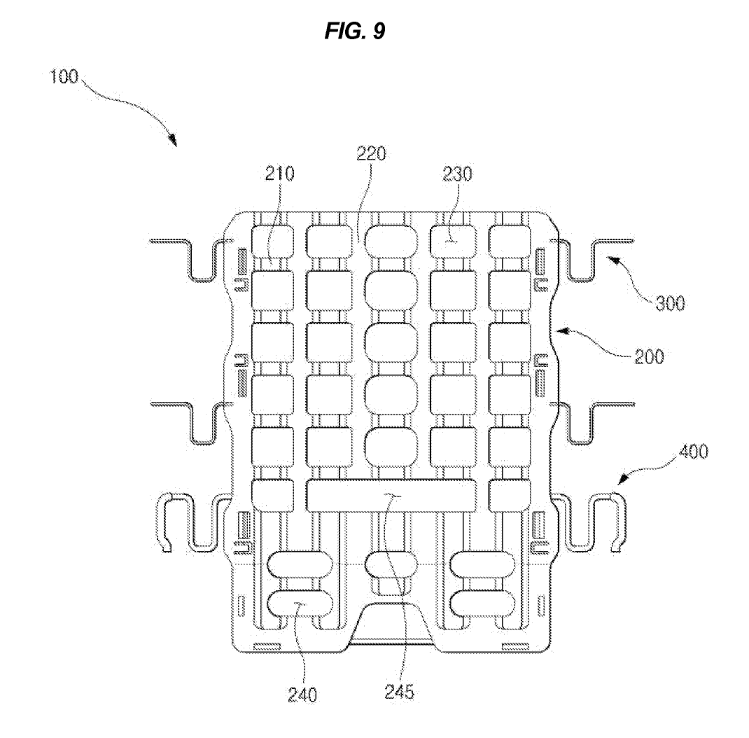

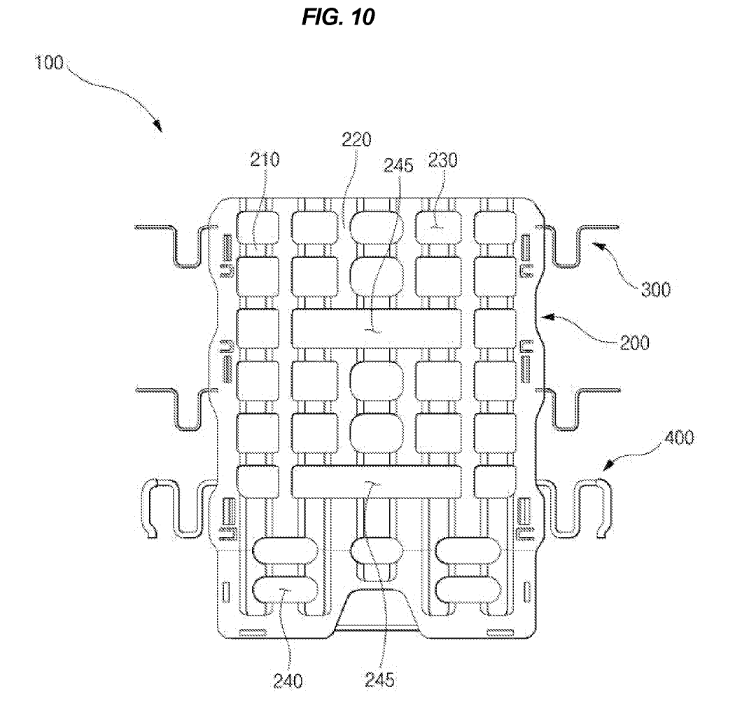

As shown in FIGS. 9 and 10, a cut-hole 245 with a variety of shapes can be formed on diverse locations on the lumbar plate 200. For example, a single cut-hole 245 may be formed by cutting two adjacent widthwise ribs 220 and horizontally connecting three adjacent openings 230.

In forming a single cut-hole 245 by cutting adjacent lengthwise or widthwise ribs 210 or 220 and inter-connecting the plurality of openings 230, the position and number of the lengthwise or widthwise ribs 210 or 220 can be properly selected in consideration of the elasticity and strength of the lumbar plate 200.

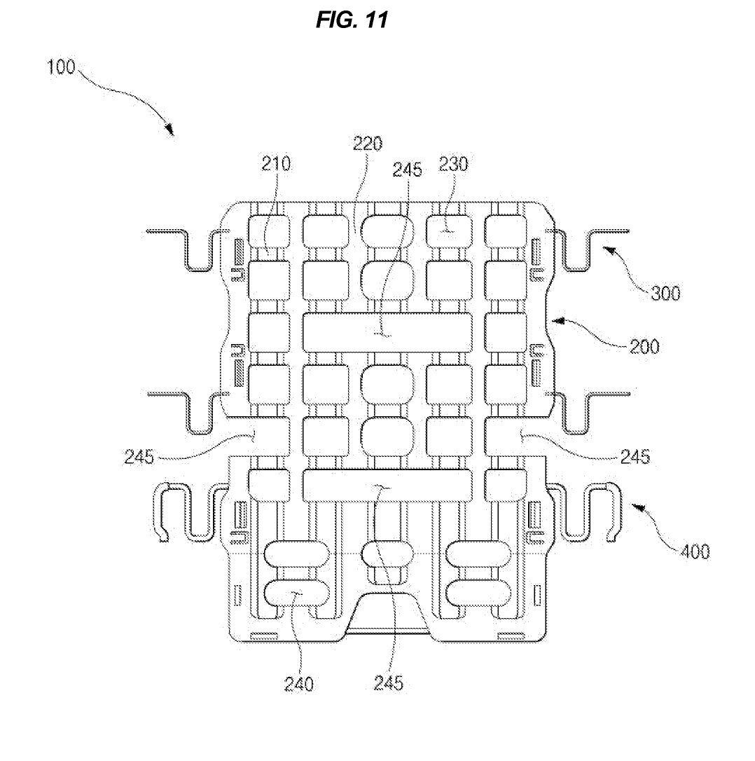

As shown in FIG. 11, a portion of the widthwise ribs 220 on opposite edges may be cut to form a cut-hole 245, thereby enabling the upper and lower portions of the lumbar plate 200 to be elastically deformed separately.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A suspension assembly of a vehicle seat, comprising:
a lumbar plate disposed within an edge of a seat back frame; and
an elastic wire section connecting the edge of the seat back frame with a side of the lumbar plate,
wherein the elastic wire section includes:
a first elastic wire, opposite ends of which are connected to one edge of the seat back frame and at least a portion thereof is supported by one side of the lumbar plate; and
a second elastic wire, opposite ends of which are connected to the other edge of the seat back frame and at least a portion thereof is supported by the other side of the lumbar plate.

2. The suspension assembly of the vehicle seat according to claim 1, wherein the elastic wire section includes:
a support extending in a longitudinal direction of the lumbar plate to support the lumbar plate and coupled to the lumbar plate;
extensions extending from upper and lower ends, respectively, of the support towards the outside of the lumbar plate; and
a hook formed on an end of the extension.

3. The suspension assembly of the vehicle seat according to claim 2, wherein the elastic wire section further includes an elastically-deformable bent part formed between the support and the extension in a shape of a letter ‘U’.

4. The suspension assembly of the vehicle seat according to claim 1,
wherein the lumbar plate is provided on opposite sides thereof with a coupler section to which a portion of the elastic wire section is inserted and fixed, and
wherein the coupler section includes:
an engaging piece forcedly supporting one side of a circumference of the elastic wire section in a first direction; and
an elastic supporting piece disposed spaced apart from the engaging piece to forcedly support in a direction opposite to the first direction, the other side of the circumference of the elastic wire section.

5. The suspension assembly of the vehicle seat according to claim 4, wherein the coupler section further includes an elastic engaging piece shaped in a hook extending from a surface of the lumbar plate to support a portion of the elastic wire section.

6. The suspension assembly of the vehicle seat according to claim 5, wherein the engaging piece has:
a vertical part extending from one side of the lumbar plate;
a horizontal part extending from opposite ends of the vertical part towards the inside of the lumbar plate;
an engaging step to receive a portion of the elastic wire section; and
a reinforcing part downwardly inclined outwards from an upper end of the vertical part.

7. The suspension assembly of the vehicle seat according to claim 6, wherein the engaging step extends from a lower end of the horizontal part.

8. The suspension assembly of the vehicle seat according to claim 1, further comprising a fixing wire section, opposite ends of which are respectively connected to opposite edges of the seat back frame to elastically support a lower side edge of the lumbar plate.

9. The suspension assembly of the vehicle seat according to claim 8, wherein the fixing wire section includes:
a horizontal fixing part extending in a widthwise direction along the lower edge of the lumbar plate and coupled to the lumbar plate;
vertical fixing parts extending vertically upwards from opposite ends of the horizontal fixing part respectively; and
a frame fixing part extending from an end of the vertical fixing part towards the outside of the lumbar plate and having an end fixed to one side of the seat back frame.

10. The suspension assembly of the vehicle seat according to claim 9, wherein the fixing wire section further includes an elastically-deformable bent portion formed between the frame fixing part and the vertical fixing part in a shape of a letter ‘U’.

11. The suspension assembly of the vehicle seat according to claim 9, wherein the lumbar plate is provided on a lower end edge thereof with a fitting piece for fixing the horizontal fixing part of the fixing wire section to the lumbar plate.

12. The suspension assembly of the vehicle seat according to claim 11, wherein the fitting piece includes a pair of opposite sidewalls with a lengthwise insertion slot formed therebetween and a fixing groove to fix the horizontal fixing part therein.

13. The suspension assembly of the vehicle seat according to claim 9, wherein the vertical fixing part is coupled to the lumbar plate by an engaging piece.

14. The suspension assembly of the vehicle seat according to claim 1, wherein the lumbar plate is curved in a widthwise direction into an irregular form.

15. The suspension assembly of the vehicle seat according to claim 1,
wherein the lumbar plate includes a plurality of openings defined by a plurality of lengthwise ribs and a plurality of widthwise ribs, and
wherein the lengthwise rib is provided with at least one elastically-deformable bent portion.

16. The suspension assembly of the vehicle seat according to claim 15, wherein the at least one elastically-deformable bent portion includes:
a pair of slant faces inclined towards a back side of the lumbar plate between adjacent widthwise ribs; and
a connecting face connecting the pair of slant faces.

17. The suspension assembly of the vehicle seat according to claim 16, wherein a reinforcing rib is provided in at least one of the lengthwise rib and widthwise rib.
